(19) United States
(12) Patent Application Publication
(10) Pub. No.: US 2009/0323087 A1
(43) Pub. Date: Dec. 31, 2009

(54) Systems and Methods for Document Redaction

(75) Inventor: Qi Luo, Foster City, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 12/165,442

(22) Filed: Jun. 30, 2008

(51) Int. Cl. G06F 15/00

(52) U.S. Cl. 358/1.9

(57) ABSTRACT

Systems and methods consistent with disclosed embodiments provide for a method for redacting documents comprising associating at least one redaction template with a document, wherein the redaction template includes information identifying at least one section of a document to be redacted. The document can be printed using the redaction template, wherein information in the redaction template is used to redact sections of the document prior to printing the document on a print medium. In some embodiments, the redaction template, and the document associated with the redaction template may be separate files. The method can be invoked using document processing software, and/or a printer driver, and user interfaces associated with document processing software may be used to create the redaction template, which can be stored as a document layer. Redactions stored in the template may also be associated with a security level.

### BACKGROUND

1. Field of the Invention

The present invention relates to the field of printing, and in particular to systems and methods for redacting documents.

2. Description of Related Art

Computer printers, which are ubiquitous in most modern organizations, permit the quick printing of stored documents. Designers of modern printers have focused relentlessly on improving printer speed, throughput, features, efficiency, and cost resulting in virtually universal adoption of printers. However, the quick access to electronic documents and the relative ease with which they can be printed can pose document security related issues to organizations. For example, an organization may wish to redact portions of a document before releasing a printed copy of the document to a third party. The redactions may pertain to sensitive information such as bank account numbers, personal details etc., which may compromise privacy and create security risks for the organization. In another situation, the document may be defense or national security related and the redacted information may pertain to sensitive strategies, specifications, minutes, etc., whose secrecy may need to be maintained.

Redacting documents can be a cumbersome process. Although portions of a document can be marked as sensitive at the time a document is created and/or updated, there is no guarantee that the information marked sensitive will remain so, or that the status of material not previously considered sensitive has not changed. In practice therefore, redactions to a document are typically occur just prior to its release in printed form when the ability to gauge the sensitivity of information contained in the document is better.

Moreover, a single document may have multiple redacted versions when printed and the redactions may vary depending on the parties receiving the printed document. For example, for document recipients with different security clearances, redactions in a printed document may depend on the individual security levels of the recipients. Further, for reasons of security, consistency, and document control, an organization may prefer to minimize the number of electronic versions of a document. Access to an electronic document can be better controlled when there are fewer versions of the document in existence. Consistency across redactions can be maintained when the redactions are based on the same electronic source document. Additionally, with fewer electronic versions of a document in existence, an organization may prefer to minimize the number of edits made to the document directly for redaction purposes in order to reduce the risk of inadvertent data corruption and loss during the redaction process. In such situations, the complexity of the redaction task increases significantly. Thus, there is a need for a simple, efficient, and easily deployable methods and systems that facilitate the redaction of documents for printing.

### SUMMARY

In accordance with disclosed embodiments, apparatus, systems, and methods for redacting documents for printing are presented. In some embodiments, a method for redacting documents comprises: associating at least one redaction template with a document, wherein the redaction template includes information identifying at least one section of a document to be redacted; and printing the document using the redaction template, wherein information in the redaction template is used to redact sections of the document prior to printing the document on a print medium.

Embodiments of the present invention also relate to software, firmware, and program instructions created, stored, accessed, or modified by processors using computer-readable media or computer-readable memory. The methods described may be performed by systems, including a computer and/or a printing device. These and other embodiments are further explained below with respect to the following figures.

### BRIEF DESCRIPTION OF THE DRAWINGS

FIG. 1 shows a block diagram of a system for redacting documents.

FIG. 2 depicts exemplary objects used in the document redaction process.

FIG. 3 shows a flowchart describing an exemplary method for redacting documents.

FIG. 4 depicts an exemplary user interface showing user configurable options in a system for redacting documents.

### DETAILED DESCRIPTION

In accordance with the present invention, systems and methods for redacting documents are presented.

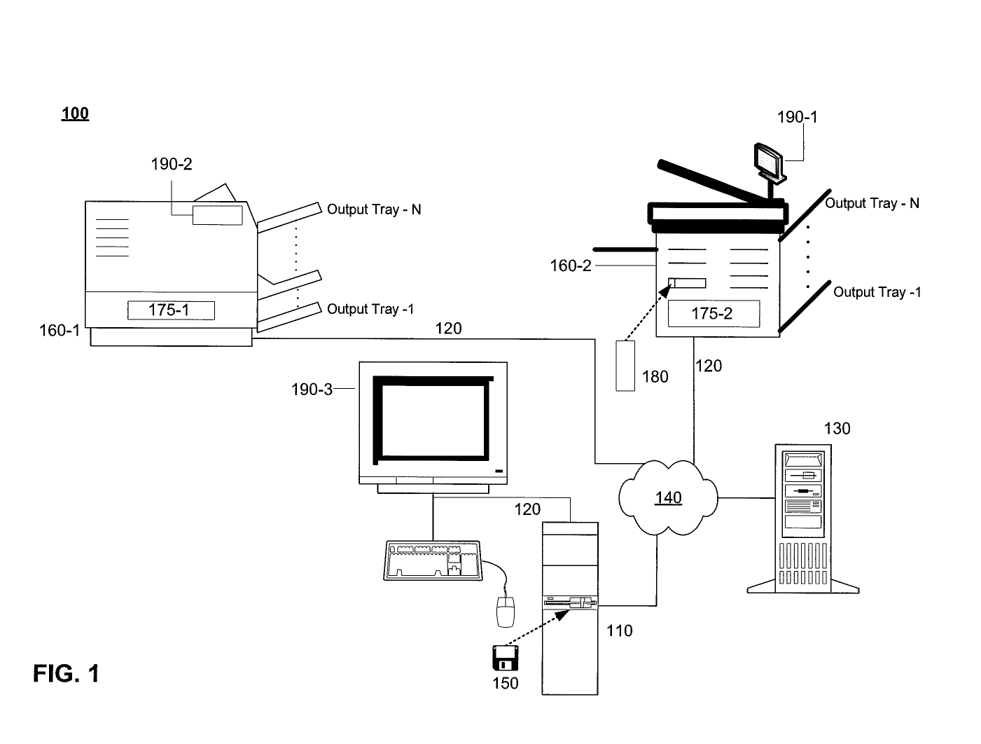

FIG. 1 shows a block diagram of exemplary system 100 for redacting documents. A computer software application consistent with the present invention may be deployed on a network of computers and/or printers, as shown in FIG. 1, that are connected through communication links that allow information to be exchanged using conventional communication protocols and/or data port interfaces.

As shown in FIG. 1, exemplary system 100 includes a computer or computing device 110 and a server 130. Further, computing device 110 and server 130 may communicate over a connection 120, which may pass through network 140, which in one case could be the Internet. Computing device 110 may be a computer workstation, desktop computer, laptop computer, or any other computing device capable of being used in a networked environment. Server 130 may be a platform capable of connecting to computing device 110 and other devices too (not shown). Computing device 110 and server 130 may be capable of executing software (not shown) that allows the redacting of documents to be printed on printers 160-1 and 160-2.

Printers 160 may be laser printers, ink jet printers, LED printers, plotters, multi-function devices, or other devices that are capable of printing documents. Computing device 110 may contain a removable media drive 150. Removable media drive 150 may include, for example, 3.5 inch floppy drives, CD-ROM drives, DVD ROM drives, CD±RW or DVD±RW drives, USB flash drives, and/or any other removable media drives consistent with embodiments of the present invention. Portions of software applications may reside on removable media and be read and executed by computing device 110 using removable media drive 150. In some embodiments, intermediate and final results and/or data generated by applications may also be stored on removable media.

Connection 120 couples computing device 110, server 130, and printers 160 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as serial, parallel, USB, SCSI, FIREWIRE, and/or Ethernet ports for transmission of data through the appropriate connection 120. The communication links could be wireless links or wired links or any combination that allows communication between computing device 110, server 130, and printers 160.

Network 140 could include a Local Area Network (LAN), a Wide Area Network (WAN), or the Internet. In some embodiments, information sent over network 140 may be encrypted to ensure the security of the data being transmitted. Exemplary printing device 160-2, may be a network printer, and can be connected to network 140 through connection 120.

System 100 may include multiple printing devices 160 and other peripherals (not shown), according to embodiments of the invention. Printing devices 160 may be controlled by hardware, firmware, or software, or some combination thereof. Printing devices 160 may include one or more print controller boards 175, such as exemplary print controllers 175-1 and 175-2, which may control the operation of printing devices 160. Printing devices 160 may be controlled by firmware or software resident on memory devices in print controllers 175. In general, print controllers 175 may be internal or external to print devices 160. In some embodiments, printing devices 160 may also be controlled in part by software, including print servers, or other software, running on computing device 110 or server 120.

Printing devices, such as exemplary printing devices 160, may also include consoles 190 such as consoles 190-1 and 190-2, or other interfaces. In some embodiments, consoles 190 may allow users to preview redacted documents, or make additional redactions to documents to be printed on printers 160. In one embodiment, consoles 190-1 and 190-2 may allow configuration options for printers 160 to be set, passwords and/or user identification and authentication information to be entered, and other messages to be displayed. In some embodiments, console 190 may take the form of a display or user-interface on a monitor for a computer coupled to printing devices 160. For example, redacted documents, or a document to be redacted prior to printing, may be displayed using appropriate user interfaces on monitor 190-3. Further, user interfaces to set one or more configuration options on printing device 160-1 may also be displayed on monitor 190-3, which is coupled to computer 110. In some embodiments, applications related to printers 160 such as document redaction may be performed and displayed using software running on server 130.

In some embodiments, configuration parameters pertaining to printing device 160 may be user-configurable. For example, pre-print options, print resolution, document sizes, color options, and other configuration parameters may be user-configurable. Pre-print options may include options to redact a document for printing. A user may also be able to specify input and/or output trays and the use of automatic document feeders to allow batch processing of documents. Users may also be able to log into a printing device 160 to perform administrative functions such as to enable software or firmware on printing device 160 to perform various functions. In some embodiments, the log in process may require a password or other user-authentication mechanism.

A computer software application consistent with the present invention may be deployed on any of the exemplary computers, or printers as shown in FIG. 1. For example, computing device 110 could execute software that may control and/or monitor the redaction and printing of documents using printer 160-1. An independent application may also execute concurrently to redact documents for printing on printer 160-2 based on its configuration. In another example, an application to redact documents for printing on printer 160-1 could reside and execute on print controller 175-1, but may be invoked and configured using computer 110. In general, applications may execute in whole or in part on one or more computers, print controllers, or printers in the system. The embodiments described above are exemplary only and other embodiments and implementations will be apparent to one of reasonable skill in the art.

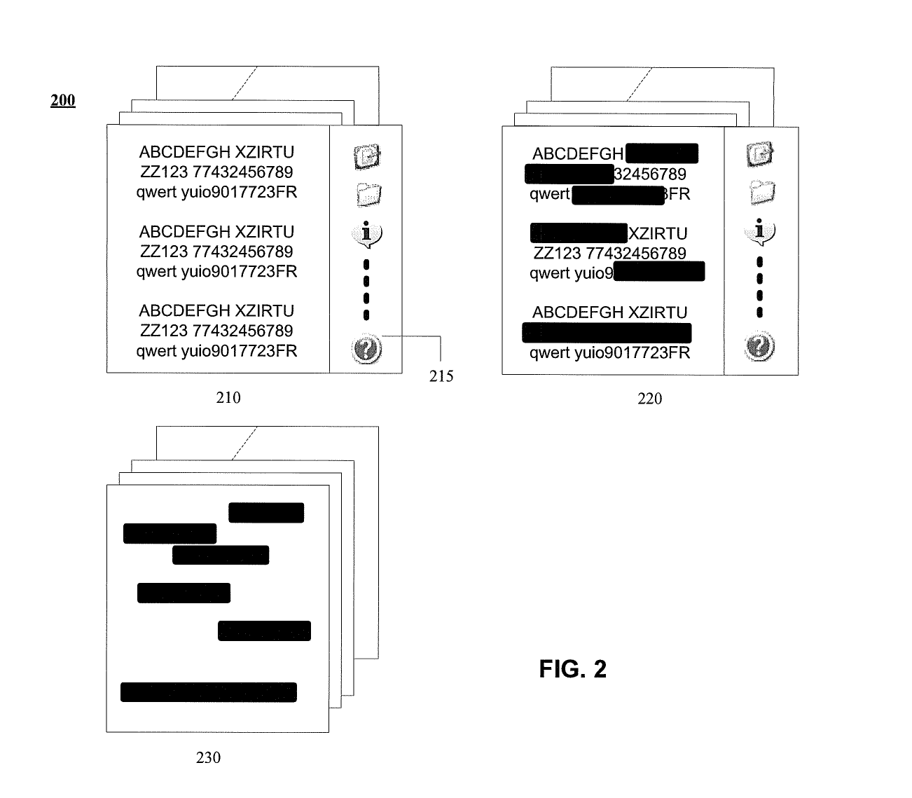

FIG. 2 shows some exemplary objects 200 used in the document redaction process. As shown in FIG. 2, document image or another appropriate representation 210 of a document can undergo redaction using a user-interface 215, which may be populated with icons, menus, and other options to facilitate the redaction process. In some embodiments, document image 210 may correspond to a bit-mapped image of a document. Document image 210 may comprise of a series of images corresponding to pages in the document. In general, document image 210 can be any representation of a document that would allow user markings made using the document representation to be correlated with document sections when the document in printed. In some embodiments, user markings may correspond to redactions. For example, sections of document image 210 can be marked to indicate that these sections should not be printed.

Because most modern document processing software operates on a “What You See Is What You Get” (“WYSIWYG”) principle, redaction software may be integrated with, or operate in conjunction with, or operate as a software layer on top of document processing software. In such embodiments, redactions may be performed using the document processing software's displayed image of a document in WYSIWYG mode, thereby allowing the user to use a familiar interface. In some embodiments, additional icons or menu buttons may be provided to facilitate the redaction.

Redacted document image 220, shown for illustrative purposes only, indicates how the redacted document would appear when it is printed, or displayed to the user during the redaction marking and template creation process. User-markings indicating redacted sections may be saved separately as redaction template 230. In one embodiment, exemplary redaction template 230 may be a bit mapped file comprising of series of bitmapped redacted pages. Each bitmapped redacted page can be a bitmapped image indicating the redacted sections of a corresponding page in the document. For example, the bitmapped redacted page indicating the redacted sections of a page in the document may comprise of opaque bands as shown in redaction template 230 in FIG. 2. As used in this description bands refers to any type of marking that can serve to redact documents.

In another embodiment, exemplary redaction template 230 may be a text file, or some other file type that is capable of providing an indication of the location and extent of each redaction. In some embodiments, redaction template 230 can also store an assigned security level associated with each redaction. The security level may correspond to the security clearances or security levels entered by the user at the time of making redactions to document 210. For example, a user may assign a security level of 4 to redactions made to a document. Another user may make further redactions and assign a security level of 3 to the redactions. When a user with a security level S views the document, those redactions with assigned security levels higher than S will be loaded for document 210. Thus, a single redaction template can be applied to a document to print out redacted copies corresponding to a variety of security levels. In some embodiments, location information may include page number, starting offset within the page, and extent of the redaction, which may be used to obtain a bitmapped redacted page. In general, redaction template 230 may be any file with bitmapped redacted pages corresponding to pages in an associated document; or any file that is capable of being transformed into a series of bitmapped redacted pages corresponding to pages in an associated document. In some embodiments, redaction template 230 may be seen as a document layer by document processing software.

In some embodiments, saved redaction template 230 corresponding to a document may be loaded and processed by printers 160 to effectuate a redaction of the printed document. For example, redaction template 230 for a document page may be rasterized and blended with the rasterized image of the page in the frame buffer of printers 160. The blended image of the page with any redacted sections may then be printed by printers 160. In some embodiments, redaction template 230 may be saved on a storage device or non-volatile memory coupled to printers 160. In some embodiments, redaction template 230 may be saved in the same location as the document on which it operates. In some embodiments, attributes of the document operated upon using redaction template 230 may be modified to indicate that the document is associated with a redaction template.

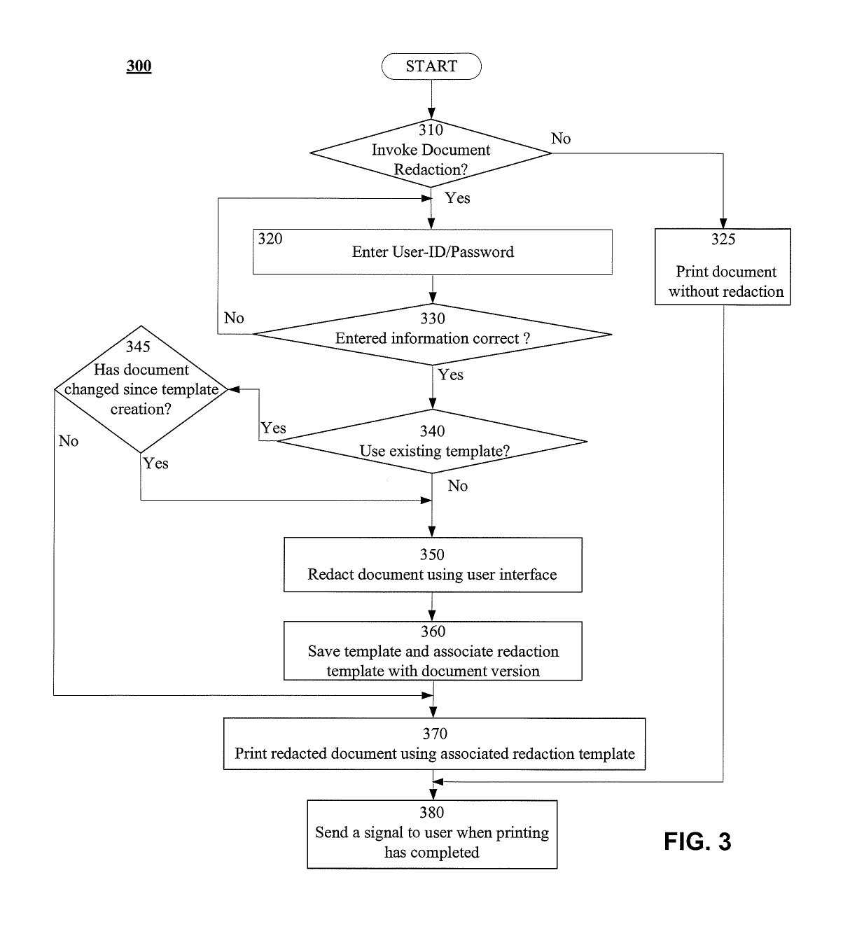

FIG. 3 depicts a flowchart describing an exemplary method 300 for redacting documents. In some embodiments, exemplary method 300 may be invoked by a user-interface associated with a printer driver for printers 160 at the time of document printing. In other words, the exemplary method 300 may be carried out as a pre-printing process as a part of setting of print preference settings. In one embodiment, exemplary method 300 may be performed by algorithms implemented using some combination of hardware, software, and/or firmware on computer 110, server 130, and/or printers 160. In step 310, a user can indicate whether document redaction is to be performed on a document to be printed. If no redaction is to be performed, then the document may be printed without redaction in step 325.

In some embodiments, if document redaction has been indicated then the user may be asked to input a user-id and password in step 320. For example, the user-id and password information may be requested by the printer driver to ensure that the user is authorized to make changes to the document and/or changes to existing redaction template 230 associated with the document.

The entered information is verified by computing device 110, in step 330. For example, computer 110 may verify the information by using a local database or by requesting information from server 130 using network 140. In some embodiments, communication between computer 110 and server 130 to verify user information may be encrypted. If the entered information is correct the algorithm can proceed to step 340. If the entered information is incorrect, the user may be asked to repeat the process. In some embodiments, repeated failures may result in suspension of the user-id and/or a notification to the system administrator or security personnel.

In step 340, an existing or new redaction template 230 may be specified. If the user elects to use a new redaction template, then, in step 350, the user may be able to make redactions to document image 210 using an appropriate user interface to select document sections for redaction. When the user has finished with redaction operations, the template may be saved and associated with the document and/or a document version number. For example, if redaction operations are performed using a viewer associated with document processing software, options may be available to associate the saved redaction template with the source document. In some embodiments, where a Revision Control System (“RCS”) tracks document versions and changes, redaction templates for document versions may be associated with corresponding versions of the document in the revision control system.

In step 340, if the user selects an existing redaction template to perform redaction operations, then in step 345, the document may be checked to verify that it has not been changed since the template was created. If the document has changed, then an appropriate user interface to select document sections for redaction may be invoked in step 350 to permit the user to make changes to redaction template 230. In some embodiments, where a “track changes” feature is available in document processing software, an existing redaction template may be overlaid on the “original” document associated with document template 230 so that more recent document changes can be identified and redaction template 230 can be changed appropriately in an incremental manner.

In step 370, the user may print the document with its associated redaction template 230. For example, if document 210 has not changed since redaction template 230 was created then document 210 may be printed using redaction template 230. Document 210 may also be printed using redaction template 230 that has been newly created and saved in step 360. When printing has been completed, the user may be notified in step 360.

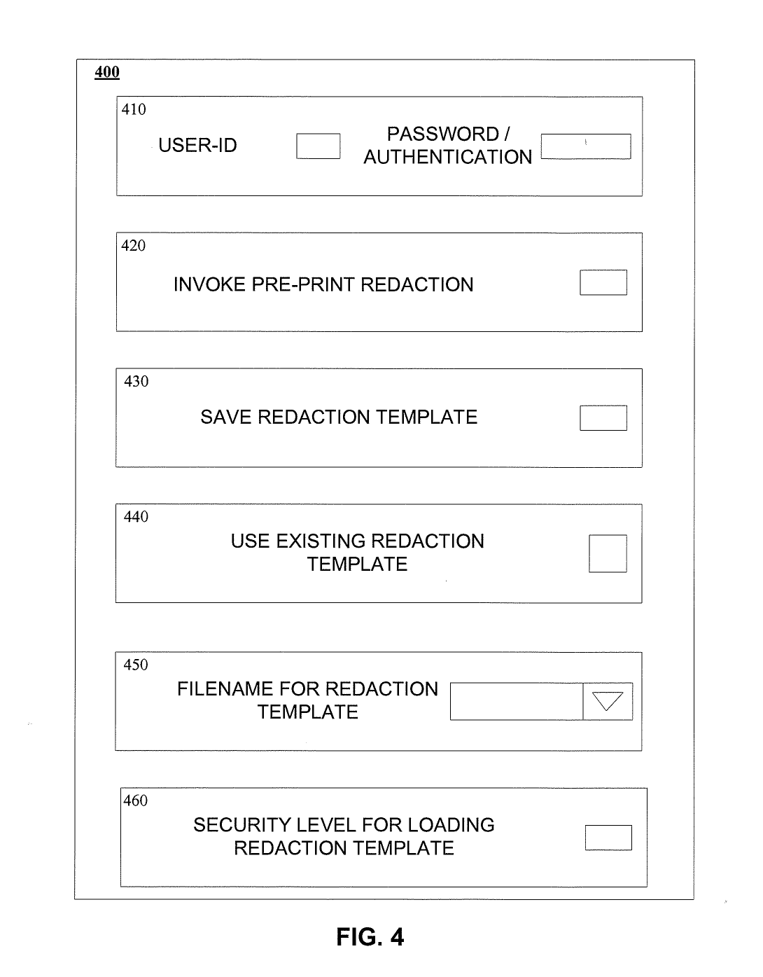

FIG. 4 depicts an exemplary user interface showing user configurable options in a system for redacting documents. It should be noted that the user interface is exemplary only and other interfaces and options may be provided to configure documents for redaction. In exemplary box 410, the user may enter a user-id and password, which can be verified before the specified redaction process is invoked. In box 420, the user may specify that the redaction process should be invoked. The user may specify that existing redaction template 230 can be used for printing document 210 using an indicator in box 440. If the user does not indicate that an existing redaction template is to be used, a new template may be created. The user may indicate that the new template is to be saved in box 430. In box 450, the user may specify the name of a file to be used as redaction template 230, or the name of newly created redaction template 230. In some embodiments, the user interface may be provided as a “printer configuration” option and integrated with document processing software. In box 460, the user may also specify a security level to be used for loading redaction template 230. In some embodiments, those redactions, which have security levels higher than the user selected security level, will be loaded for document 210.

Further, methods consistent with embodiments of the invention may conveniently be implemented using program modules, hardware modules, or a combination of program and hardware modules. Such modules, when executed, may perform the steps and features disclosed herein, including those disclosed with reference to the exemplary flow charts shown in the figures. The operations, stages, and procedures described above and illustrated in the accompanying drawings are sufficiently disclosed to permit one of ordinary skill in the art to practice the invention. Moreover, there are many computers and operating systems that may be used in practicing embodiments of the instant invention and, therefore, no detailed computer program could be provided that would be applicable to these many different systems. Each user of a particular computer will be aware of the language, hardware, and tools that are most useful for that user's needs and purposes.

The above-noted features and aspects of the present invention may be implemented in various environments. Such environments and related applications may be specially constructed for performing the various processes and operations of the invention, or they may include a general-purpose computer or computing platform selectively activated or reconfigured by program code to provide the functionality. The processes disclosed herein are not inherently related to any particular computer or other apparatus, and aspects of these processes may be implemented by any suitable combination of hardware, software, and/or firmware.

Embodiments of the present invention also relate to compute-readable media that include program instructions or program code for performing various computer-implemented operations based on the methods and processes of embodiments of the invention. The program instructions may be those specially designed and constructed for the purposes of the invention, or they may be of the kind well known and available to those having skill in the computer software arts. Examples of program instructions include, for example, machine code, such as produced by a compiler, and files containing a high-level code that can be executed by the computer using an interpreter.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims. As such, the invention is limited only by the following claims.

1. A method for redacting documents comprising:
associating at least one redaction template with a document, wherein the redaction template includes information identifying at least one section of a document to be redacted; and
printing the document using the redaction template, wherein information in the redaction template is used to redact the at least one identified section of the document prior to printing the document on a print medium.

2. The method of claim 1, wherein the redaction template, and the document associated with the redaction template are separate files.

3. The method of claim 1, wherein the redaction template is stored as a document layer.

4. The method of claim 1, wherein the method is performed on one of
a computer;
a printer; and
a computer coupled to a printer.

5. The method claim 1, wherein the method is invoked using document processing software.

6. The method of claim 1, wherein the method is invoked from a console coupled to a printer.

7. The method of claim 1, wherein the method is invoked from a user interface associated with printer driver software.

8. The method of claim 1, wherein the redaction template comprises bitmapped redacted pages, wherein each bitmapped redacted page comprises opaque bands that correspond to the location and extent of sections of a page identified for redaction in the document.

9. The method of claim 1, wherein redacting sections of the document prior to printing the document on a print medium further comprises:
using information in the redaction template to create at least one bitmapped redacted page, wherein the bitmapped redacted page comprises opaque bands that correspond to the location and extent of sections of a page identified for redaction in the document; and
blending the bitmapped redacted page with the bitmapped image of the page in the document.

10. The method of claim 1, wherein the redaction template is created using user interfaces associated with document processing software.

11. The method of claim 1, wherein associating at least one redaction template with a document further comprises using a document attribute to identify the redaction template associated with the document.

12. The method of claim 1, wherein the information included in the redaction template comprises a security level associated with each redaction.

13. A computer-readable medium that stores instructions, which when executed by a processor perform steps in a method for redacting documents comprising:
associating at least one redaction template with a document, wherein the redaction template includes information identifying at least one section of a document to be redacted; and
printing the document using the redaction template, wherein information in the redaction template is used to redact the at least one identified section of the document prior to printing the document on a print medium.

14. The computer readable medium of claim 13, wherein the redaction template, and the document associated with the redaction template are separate files.

15. The computer readable medium of claim 13, wherein the redaction template is stored as a document layer.

16. The computer readable medium of claim 13, wherein the redaction template comprises bitmapped redacted pages, wherein each bitmapped redacted page comprises opaque bands that correspond to the location and extent of sections of a page identified for redaction in the document.

17. The computer readable medium of claim 13, wherein redacting sections of the document prior to printing the document on a print medium further comprises:
using information in the redaction template to create at least one bitmapped redacted page, wherein the bitmapped redacted page comprises opaque bands that correspond to the location and extent of sections of a page identified for redaction in the document; and
blending the bitmapped redacted page with the bitmapped image of the page in the document.

18. The computer readable medium of claim 13, wherein the redaction template is created using user interfaces associated with document processing software.

19. A computer-readable medium that stores instructions, which when executed by a processor perform steps in a method for redacting documents comprising:
associating at least one redaction template with a document, wherein the redaction template includes information identifying at least one section of a document to be redacted; and
printing the document using the redaction template, wherein information in the redaction template is used to redact the at least one identified section of the document prior to printing the document on a print medium.

20. The computer readable memory of claim 19, wherein the redaction template, and the document associated with the redaction template are separate files.

21. The computer readable memory of claim 19, wherein the redaction template comprises bitmapped redacted pages, wherein each bitmapped redacted page comprises opaque bands that correspond to the location and extent of sections of a page identified for redaction in the document.

22. The computer readable memory of claim 19, wherein redacting sections of the document prior to printing the document on a print medium further comprises:
using information in the redaction template to create at least one bitmapped redacted page, wherein the bitmapped redacted page comprises opaque bands that correspond to the locations and extent of sections of a page identified for redaction in the document; and
blending the bitmapped redacted page with the bitmapped image of the page in the document.
